(19) United States
(12) Patent Application Publication
(10) Pub. No.: US 2019/0339930 A1
(43) Pub. Date: Nov. 7, 2019

(54) Music Reproduction Program, Music Reproduction Device, and Music Reproduction Method

(71) Applicant: JVCKENWOOD Corporation

(72) Inventors: Toru KAIWA, Yokohama-shi (JP); Masashi UEMOTO, Yokohama-shi (JP); Takashi KUDO, Yokohama-shi (JP)

(21) Appl. No.: 16/510,189

(22) Filed: Jul. 12, 2019

Related U.S. Application Data
(63) Continuation of application No. PCT/JP2017/037863, filed on Oct. 19, 2017.

(30) Foreign Application Priority Data
Jan. 31, 2017 (JP) 2017-015260

(51) Int. Cl. G06F 3/16; G10H 1/00

(52) U.S. Cl. CPC G06F 3/165; G10H 2220/101; G10H 1/0008

(57) ABSTRACT

A music reproduction program causes a computer to execute a graph setting step, a music selection step, and a reproduction step. The graph setting step sets a BPM graph showing the tempo of music file that a user listens to from the start of exercise to the end of exercise. The music selection step selects, when selecting the music file that the user listens to at any progress time in the distance or time after the start of the exercise, a music file having a BPM value within the predetermined range based on the BPM value at the progress time in the graph. The music selection step selects a music file having a BPM value within a predetermined range based on the BPM value set in the graph at the progress time point when reproduction of the entire music file is completed. The reproduction step reproduces the selected music file.

### CROSS REFERENCE TO RELATED APPLICATION

This application is a Continuation of PCT Application No. PCT/JP2017/037863, filed on Oct. 19, 2017, and claims the priority of Japanese Patent Application No. 2017-015260, filed on Jan. 31, 2017, the entire contents of both of which are incorporated herein by reference.

### BACKGROUND

The present disclosure relates to a music reproduction program, a music reproduction device, and a music reproduction method for reproducing music data stored in an electronic device.

In recent years, more and more people have been doing exercise such as running while listening to music. Taking running as an example, a runner usually runs while listening to music stored in a portable terminal such as a smartphone with headphones (earphones).

### SUMMARY

When the running pace is similar to the tempo of the music being listened to, a runner can run comfortably while enjoying the music. There is a need for a music reproduction program, a music reproduction device, and a music reproduction method that can reproduce music data so that a person can exercise while enjoying music corresponding to the pace of exercise.

A first aspect of one or more embodiments provides a computer software product that includes a non-transitory storage medium readable by a processor, the non-transitory storage medium having stored thereon a set of instructions for performing music reproduction, the instructions including: a first set of instructions of setting a BPM graph showing a tempo of a music file that a user listens to from a start to an end of exercise at a distance or time preset when the user does a predetermined exercise; a second set of instructions of, when setting a music file that the user listens to at any progress time point in the distance or time after the start of the exercise, selecting a music file having a BPM value within a predetermined range based on a BPM value at a progress time point in the graph set in the setting of the graph; and a third set of instructions of reproducing the music selected in the selecting of the music to make the user listen to the music, wherein the second set of instructions selects, when selecting a second music to be reproduced next to a first music being reproduced by the third set of instructions, during the reproduction of the first music, regardless of whether or not the BPM value set in the graph exceeds the predetermined range based on a BPM value set in the graph at a progress time point when the first music is selected, a music file having a BPM value within the predetermined range based on a BPM value set in the graph at a process time point when the reproduction of the entire first music is completed.

A second aspect of one or more embodiments provides a music reproduction device including: a graph setting unit configured to set a BPM graph showing a tempo of music that a user listens to from a start to an end of exercise at a distance or time preset when the user does a predetermined exercise; a music selection unit configured to select, when a music file that the user listens to is set at any progress time point in the distance or time after the start of the exercise, a music file having a BPM value within a predetermined range based on a BPM value at a progress time point in the graph set in the graph setting unit; and a reproduction unit configured to reproduce the music selected by the music selection unit so that the user can listen to the music, wherein the music selection unit selects, when a second music to be reproduced next to a first music being reproduced by the reproduction unit, during the reproduction of the first music, regardless of whether or not the BPM value set in the graph exceeds the predetermined range based on a BPM value set in the graph at a progress time point when the first music is selected, a music file having a BPM value within the predetermined range based on a BPM value set in the graph at a process time point when the reproduction of the entire first music is completed.

A third aspect of one or more embodiments provides a music reproduction method including: setting a BPM graph showing a tempo of music that a user listens to from a start to an end of exercise at a distance or time preset when the user does a predetermined exercise by a processor of an electronic device; when selecting a music file that a user listens to among a plurality of music pieces stored in the electronic device at any progress time point from the from start to the end of the exercise, selecting a music file having a BPM value within a predetermined range based on the BPM value at the progress time point in the graph by the processor; and reproducing the selected music by a reproduction unit provided in the electronic device to make the user listen to the music, wherein the processor selects, when a second music to be reproduced next to a first music being reproduced is selected, during the reproduction of the first music, regardless of whether or not the BPM value set in the graph exceeds the predetermined range based on a BPM value set in the graph at a progress time point when the first music is selected, a music file having a BPM value within the predetermined range based on a BPM value set in the graph at a process time point when the reproduction of the entire first music is completed.

### BRIEF DESCRIPTION OF THE DRAWINGS

FIG. 1 is a block diagram illustrating a music reproduction device according to one or more embodiments.

FIG. 2 is a diagram conceptually illustrating a set of music data and a BPM value stored in the music reproduction device according to one or more embodiments.

FIG. 3 is a flowchart illustrating a process executed by a music reproduction program and a music reproduction method according to one or more embodiments, and an operation of the music reproduction device according to one or more embodiments.

FIG. 4 is a flowchart illustrating the details of a new run menu creation process in step S3 of FIG. 3.

FIG. 5 is a flowchart illustrating the details of a running history selection process of step S4 of FIG. 3.

FIG. 6A is a flowchart illustrating the details of a music selection and reproduction process of step S61 of FIG. 3.

FIG. 6B is a flowchart illustrating the details of the music selection and reproduction process of step S61 of FIG. 3 following the connectors A, C, D, and E of FIG. 6A.

FIG. 7 is a flowchart illustrating the details of an image display process of step S71 of FIG. 3.

FIG. 8 is a view illustrating an example of a menu image which is displayed on a display of the music reproduction device and selects create new and select from history in the run menu.

FIG. 9A illustrating a distance and time setting image displayed on the display when create new is selected in the menu image of FIG. 8 and is a view showing a state in which a distance is input to the distance and time setting image.

FIG. 9B is a view illustrating a state in which time is input to the same distance and time setting image as FIG. 9A.

FIG. 10 is a view illustrating an example of a graph setting image of BPM displayed on the display.

FIG. 11 is a view illustrating a state in which the graph in the graph setting image of FIG. 10 is moved.

FIG. 12 is a view illustrating a state in which the BPM value of the graph in the graph setting image of FIG. 11 is adjusted at a plurality of positions.

FIG. 13 is a view illustrating a state in which a designated music file is set in the graph setting image of FIG. 12.

FIG. 14 is a view illustrating an example of an image for instructing the start of running shown on the display.

FIG. 15 is a view illustrating an example of a running history list displayed on the display when select from history is selected in the menu image of FIG. 8.

FIG. 16 is a view illustrating an example of the details of the running history shown on the display when any of the running histories shown in FIG. 15 are selected.

FIG. 17 is a view illustrating an example of a time display image displayed on the display after the start of running is instructed.

FIG. 18 is a view illustrating an example of a graph display image displayed on the display after the start of running is instructed.

FIG. 19 illustrates a graph display image similar to FIG. 18, and is a view illustrating a state before an operation of changing the running pace is performed.

FIG. 20 is a view illustrating a state after the operation of changing the running pace is performed in the graph display image shown in FIG. 19.

FIG. 21 is a view illustrating an example of a time display image after the time when running for a preset period of time is finished.

FIG. 22 is a view illustrating an example of a time display image displayed on the display when an operation of finishing running is performed in the time display image shown in FIG. 21.

FIG. 23 is a view illustrating an example of a running result image displayed on the display when the end operation is performed in the time display image shown in FIG. 22.

FIG. 24 is a view illustrating an example of a playlist display image displayed on the display when display of a playlist is instructed in the running result image shown in FIG. 23.

FIG. 25 is a view illustrating an example of a basic music switching process executed by the music reproduction program and the music reproduction method according to one or more embodiments, and an example of a basic music switching operation executed by the music reproduction device according to one or more embodiments.

FIG. 26 is a view illustrating examples of a music switching process in the case where an operation of skipping the music file executed by the music reproduction program and the music reproduction method according to one or more embodiments is performed, and a music switching operation in the case where the operation of skipping the music file executed by the music reproduction device according to one or more embodiments is performed.

FIG. 27 is a view illustrating examples of a music switching process executed by the music reproduction program and the music reproduction method according to one or more embodiments in the case where a designated music file is set, and a music switching operation executed by the music reproduction device according to one or more embodiments in the case where a designated music file is set.

### DETAILED DESCRIPTION

Hereinafter, a music reproduction program, a music reproduction device, and a music reproduction method according to one or more embodiments will be described with reference to the accompanying drawings. In one or more embodiments, a music reproduction program, a music reproduction device, and a music reproduction method capable of selecting and reproducing a music file corresponding to the preset pace at which a runner runs taken as running as an example of exercise are exemplified.

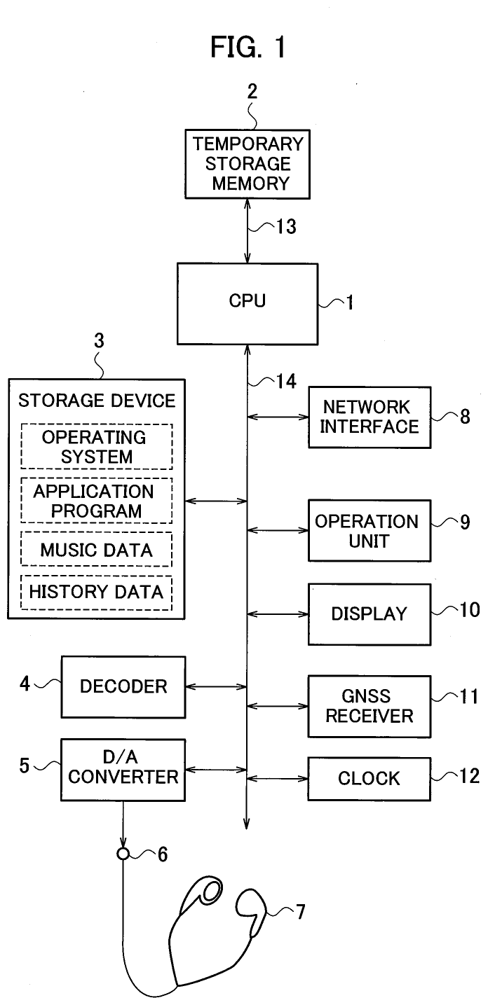

First, the configuration of the music reproduction device according to one or more embodiments will be described using FIG. 1. The music reproduction device according to one or more embodiments is a portable terminal such as a smartphone, for example. In FIG. 1, a central processing unit (hereinafter, abbreviated as CPU) 1 configured by a microprocessor controls the entire music reproduction device. Buses 13 and 14 are connected to the CPU 1. A temporary storage memory 2 configured by a RAM is connected to the CPU 1 through the bus 13.

A storage device 3, a decoder 4, a D/A converter 5, a network interface 8, an operation unit 9, a display 10, a GNSS receiver 11, and a clock 12 are connected to the CPU 1 through the bus 14. Headphones (earphones) 7 are connected to an output terminal 6 connected to the D/A converter 5. An unillustrated runner (user of a portable terminal) runs while wearing the headphones 7 on the ears.

The storage device 3 is an example of a non-transitory storage medium, and is configured by a flash memory, for example. The storage device 3 stores an operating system for operating a portable terminal, an application program which is the music reproduction program according to one or more embodiments, music data, and history data. The music data is a digitally encoded audio signal of a predetermined format.

The operation unit 9 is a touch panel integrated with operation buttons or the display 10 provided on a housing of the portable terminal. In one or more embodiments, the operation unit 9 is mainly a touch panel. The display 10 is a liquid crystal display panel or an organic electroluminescent (organic EL) panel.

The GNSS receiver 11 receives radio waves from three or more satellites for the global navigation satellite system (GNSS). GNSS is a global positioning system (GPS) as an example. The CPU 1 can detect the position of the portable terminal by the GNSS signal based on the radio wave received by the GNSS receiver 11. The GNSS receiver 11 may be configured to include a computing unit to detect the position of the mobile terminal. In this case, the GNSS receiver 11 supplies the position information to the CPU 1.

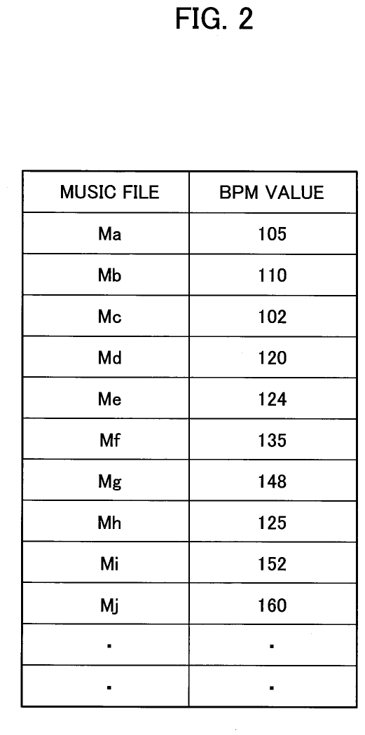

In FIG. 1, in the storage device 3, as shown in FIG. 2, the music data of each music file and the beats per minute (BPM) value of each music file are stored in association with each other. The BPM value is a value obtained by digitizing the tempo of the music file. The BPM value of the music file stored in the storage device 3 are analyzed and stored in advance by the application program.

The runner may manually set the BPM value of each music file by the operation unit 9 and store the BPM value in the storage device 3. The runner may access the Internet through the network interface 8 to obtain the BPM value of each music file from the website and store the BPM value in the storage device 3. Note that the BPM value of a music file can be easily analyzed by general purpose software.

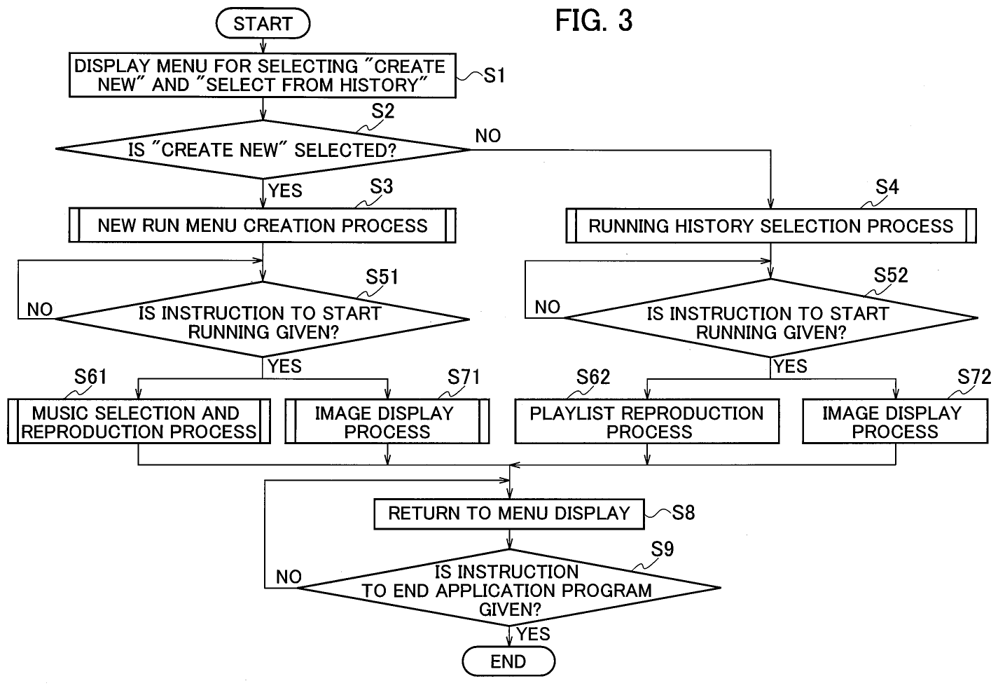

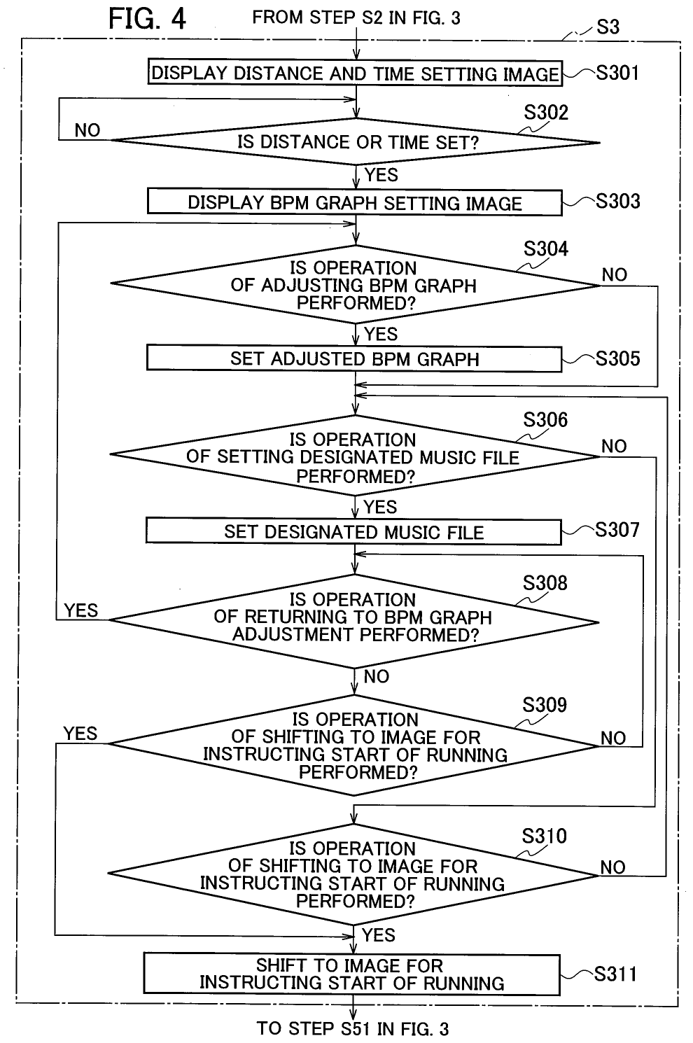

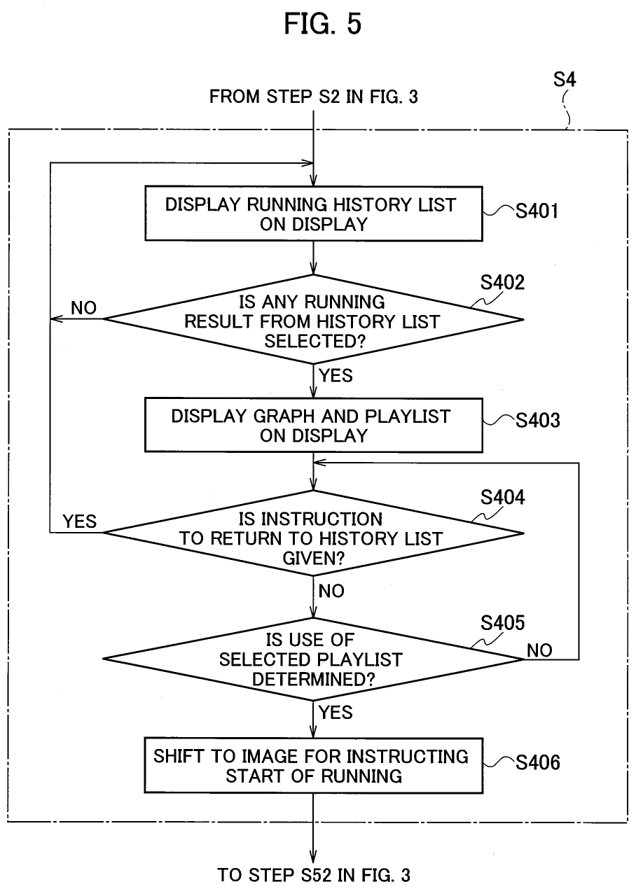

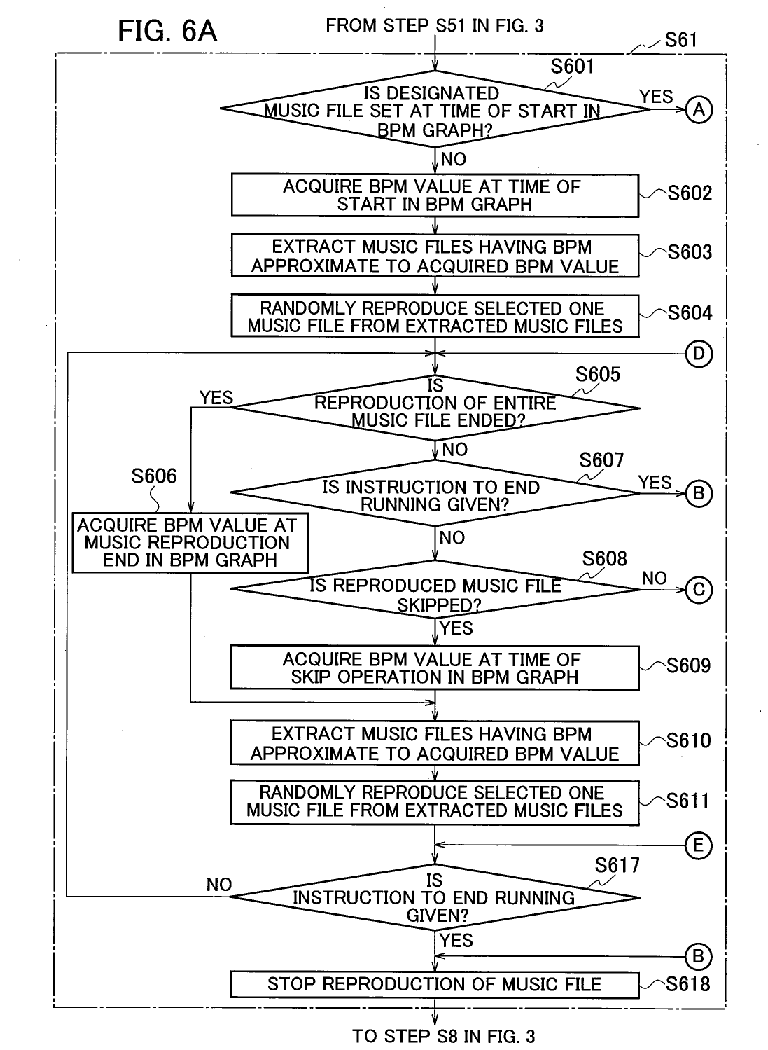

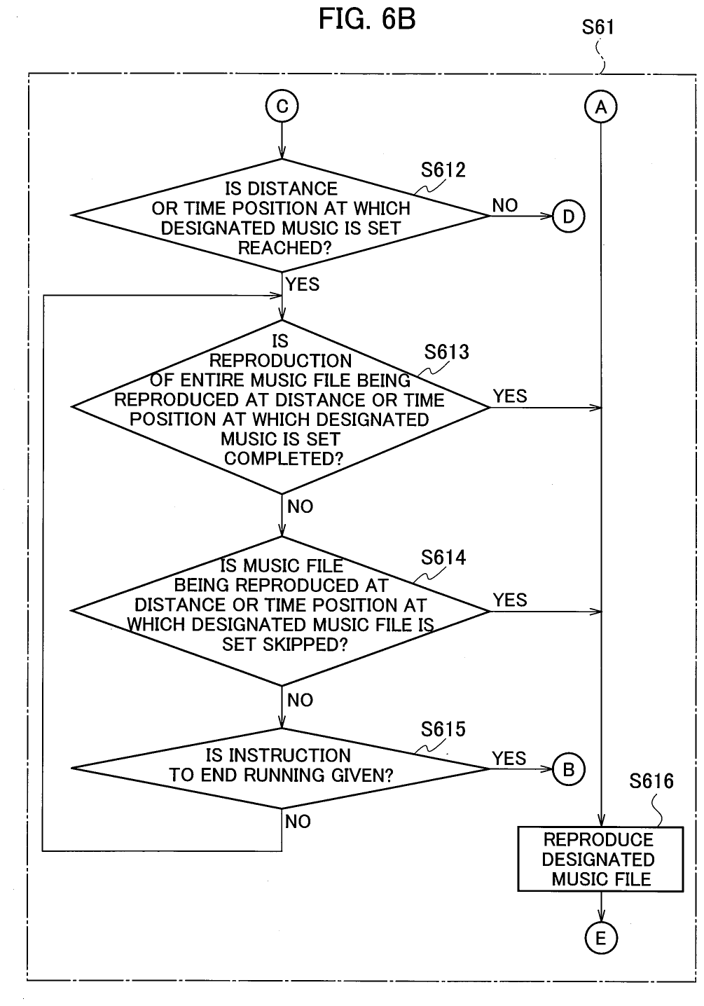

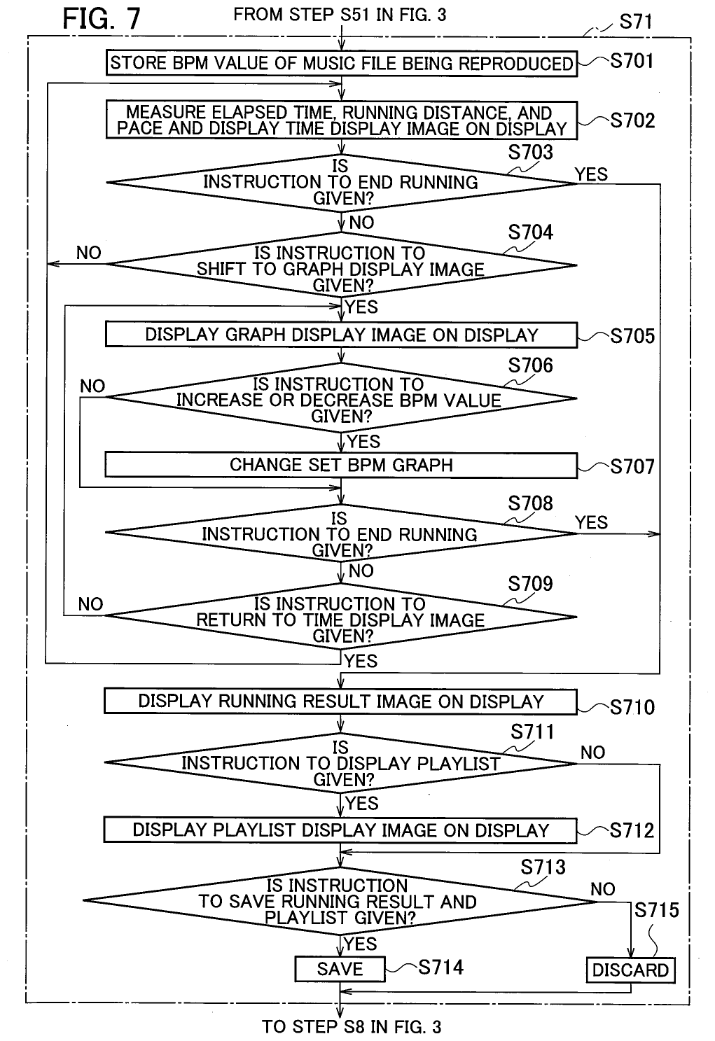

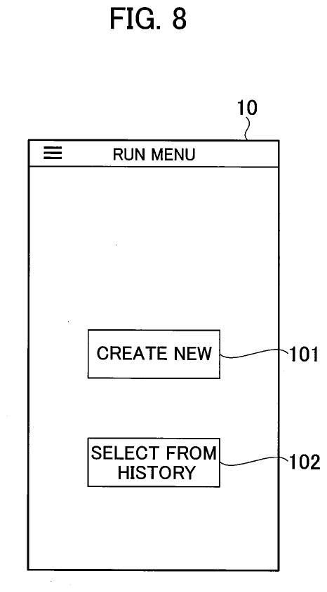

Processes executed by the music reproduction program and the music reproduction method according to one or more embodiments using the flowcharts shown in FIGS. 3 to 7 and display images of the display 10 shown in FIGS. 8 to 24, and operations of the music reproduction device according to one or more embodiments will be described.

In FIG. 3, when the runner operates the operation unit 9 to activate the music reproduction program, the CPU 1 activates the application program and the process is started. In step S1, as shown in FIG. 8, the CPU 1 displays a menu including a new creation button 101 described as “create new” and a history selection button 102 described as “select from history” on the display 10.

When the runner operates the new creation button 101, it is possible to create a new menu (hereinafter, referred to as a run menu) for associating the running plan by the runner with the music file that the runner listens to during running. When the runner operates the history selection button 102, the run menu based on the running history created by the runner in the past can be used.

In one or more embodiments, in the case where the operation unit 9 is a touch panel, operating the button shown on the display 10 means touching the button.

In step S2, the CPU 1 determines whether or not “create new” is selected by operating the new creation button 101. When “create new” is selected (YES), the CPU 1 executes a run menu new creation process in step S3, and when “create new” is not selected (that is, “select from history” is selected) (NO), a running history selection process is executed in step S4.

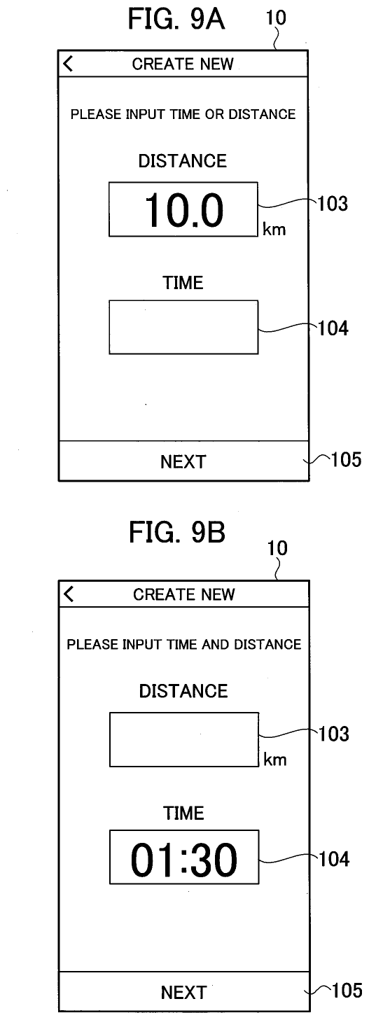

Here, the details of the new run menu creation process in step S3 will be described using FIG. 4. When “create new” is selected in step S2 of FIG. 3, the process is shifted to step S301 of FIG. 4. In FIG. 4, in step S301, the CPU 1 displays a distance and time setting image for setting the running distance or time shown in FIG. 9A or 9B on the display 10.

As shown in FIG. 9A or 9B, the distance and time setting image is a distance input window 103 for inputting a distance, a time input window 104 for inputting time, and a next image shift instruction button 105 described as “next”.

In step S302, the CPU 1 determines whether or not the distance or the time is set. When the distance or time is set by the operation of the next image shift instruction button 105 (YES), the process is shifted to step S303, and when the distance or time is not set (NO), the process of step S302 is repeated.

FIG. 9A shows a state where 10.0 (km) is input to a distance input window 103 as an example. FIG. 9B shows a state in which 01:30 (1 hour and 30 minutes) is input to a time input window 104 as an example. The distance input to the distance input window 103 and the time input to the time input window 104 can be alternatively performed. In the following description, the case where running time is set to 1 hour and 30 minutes is described as an example.

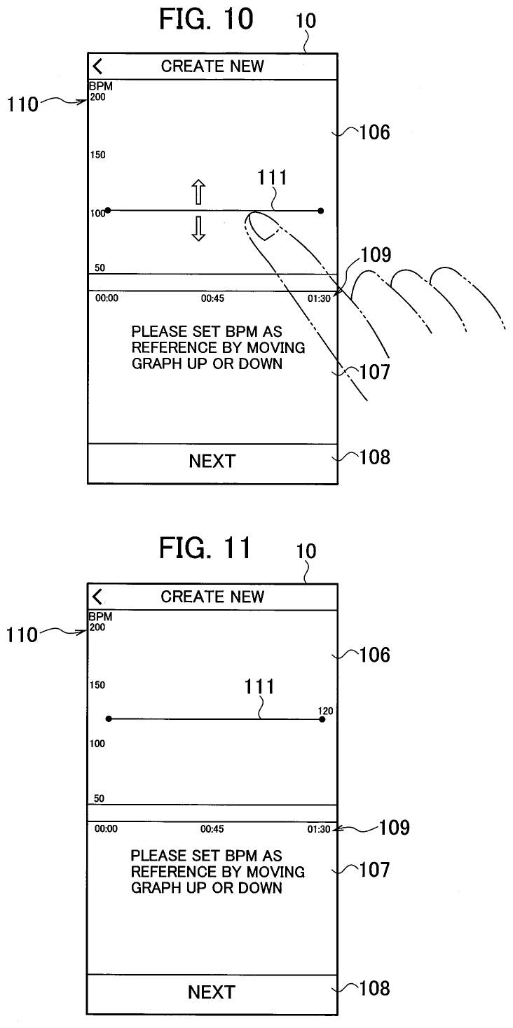

Note that the setting data of the distance or time set in FIG. 9A or 9B is stored in the temporary storage memory 2. In addition, among data for configuring an image to be displayed on the display 10 in FIG. 10 and the following drawings, and the subsequent figures, data set for running or reproducing a music file, and data relating to the music file reproduced during the running period are stored in the temporary storage memory 2.

At step S303, the CPU 1 shows a graph setting image of the BPM shown in FIG. 10 on the display 10. The BPM graph setting image includes a BPM graph display area 106, an explanatory text display area 107, and a next image shift instruction button 108. At the upper end of the explanatory text display area 107, time information 109 is displayed in the horizontal direction (left and right direction), and at the left end of the graph display area 106, BPM value information 110 is displayed in the vertical direction (up and down direction).

Here, since the running time is set to 1 hour and 30 minutes, 00:00 is displayed at the left end as the time information 109 at the time of the start of running, 00:45 is displayed at the center, and 01:30 is displayed at the right end at the time of the end of running. As the BPM value information 110, BPM values are displayed in 50-step increments from 50 at the lower end to 200 at the upper end.

The CPU 1 displays a linear graph 111 in the graph display area 106 at a position of 100 as an initial value of the BPM value. The initial value of the BPM value is not limited to 100. In step S304, the CPU 1 determines whether or not an operation of adjusting the BPM graph 111 is performed, and when the operation is performed (YES), the adjusted BPM graph 111 is set in step S305 (graph setting step).

Specifically, as shown in FIG. 10, when the runner puts a finger on the graph 111 and moves the finger up or down, the CPU 1 moves the graph 111 in the up or down direction. FIG. 11 shows a state in which the graph 111 is moved to the position of a BPM value of 120.

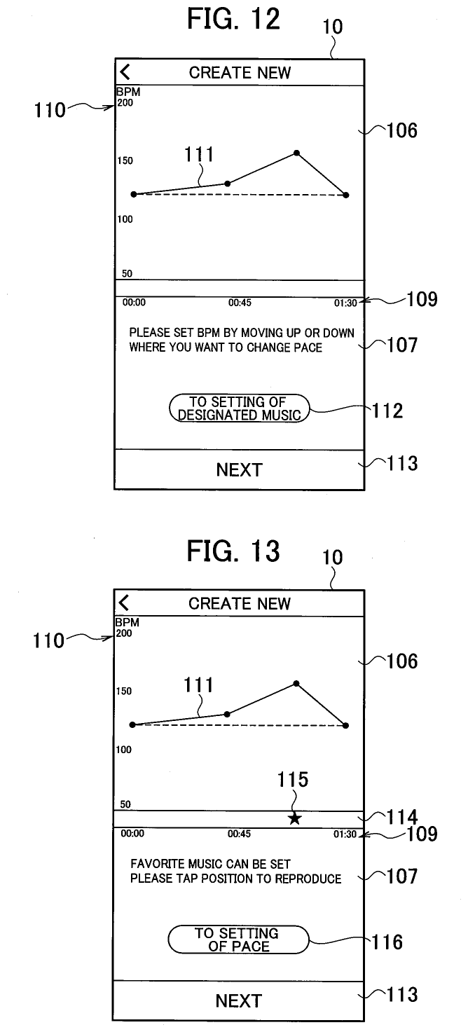

When the next image shift instruction button 108 is operated, the CPU 1 shifts to a state in which the BPM value of the graph 111 can be set at a plurality of positions as shown in FIG. 12. In FIG. 12, the BPM value is set to a value larger than a BPM value of 120 at two places between the starting end and the terminal end of the graph 111.

The graph 111 shown in FIG. 12 has the characteristics that the BPM value is gently increased from about 120 to 130 for about 40 minutes from the start of running, and then the BPM value is rapidly increased to about 160 for about 1 hour and 10 minutes, and then is decreased to about 120.

The operation of adjusting the BPM graph 111 in step S304 includes an operation of moving the graph 111 shown in FIGS. 10 and 11 in the up or down direction, and an operation of setting the BPM value of the graph 111 shown in FIG. 12 at a plurality of positions to connect a plurality of linear lines with different angles instead of one linear line.

In addition, since a music file with a high BPM value is up-tempo music, it is suitable for listening when the pace at which a runner runs is fast. Since a music file with a low BPM value is slow tempo music, it is suitable for listening when the pace at which the runner runs is slow. The runner recognizes the BPM value corresponding to the pace at which the runner runs. Therefore, the runner can adjust the BPM graph 111 in accordance with the running plan at a pace that the runner runs within a preset distance or time.

The graph 111 shown in FIG. 12 is a graph for setting the BPM value of the music file which the runner listens to during running, and shows a running plan showing the pace when the runner runs.

In step S306, the CPU 1 determines whether or not an operation of setting a designated music file is performed, and when the operation is performed (YES), the designated music file is set in step S307 (designated music setting step). Specifically, when a designated music setting shift instruction button 112 is operated in FIG. 12, as shown in FIG. 13, the CPU 1 designates an area between the graph display area 106 and the time information 109 as a designated music setting position instruction area 114.

When the runner touches one of the positions from 00:00 at the start of running to 01:30 at the end of running in the designated music setting position instruction area 114, for example, the CPU 1 displays a designated music setting mark 115 of the star mark in the designated music setting position instruction area 114. The position where the designated music setting mark 115 is displayed is the time position set to reproduce the designated music file.

However, as will be described later, in the case where the music file being reproduced is not finished immediately before the time position where the designated music setting mark 115 is displayed, the CPU 1 performs control to reproduce the designated music file after the reproduction of the music file being reproduced immediately before is completed. Therefore, the position where the designated music setting mark 115 is displayed may not be the time position to start the reproduction of the designated music file.

Here, since the time for running is set, the position in the left and right direction of the designated music setting position instruction area 114 in which the designated music setting mark 115 is displayed indicates the time position. When the distance to run is set, the position in the left and right direction of the designated music setting position instruction area 114 indicates the position on the distance. The position in the left and right direction when the time information 109 or the distance information is displayed in the left and right direction of the display 10 indicates a progress time point of the distance or time.

As an example, when the designated music setting mark 115 is touched, the CPU 1 displays a music list to select any music data from the music data stored in the storage device 3 as the designated music file. The CPU 1 sets the music data selected from the music list as the designated music file.

In step S308, the CPU 1 determines whether or not an operation of returning to the adjustment of the BPM graph 111 is performed. When the operation of returning to the adjustment of the BPM graph 111 is performed (YES), the CPU 1 returns the process to step S304. Specifically, when a graph adjustment return button 116 described as “to pace setting” is operated in FIG. 13, the CPU 1 returns the display image of the display 10 to the state of FIG. 12.

When the operation of returning to the adjustment of the BPM graph 111 is not performed (NO), the CPU 1 determines whether or not the operation of shifting to the image for instructing the start of running is performed in step S309. When the operation of shifting to the image for instructing the start of running is performed (YES), the CPU 1 shifts to the image for instructing to start running in step S311. Specifically, when a next image shift instruction button 113 described as “next” is operated in FIG. 13, the CPU 1 shifts to the image for instructing the start of running.

When it is determined that the operation of shifting to the image for instructing the start of running is not performed (NO) in step S309, the CPU 1 returns the process to step S308.

On the other hand, when the operation of setting the designated music file is not performed in step S306 (NO), the CPU 1 determines whether or not the operation of shifting to the image for instructing the start of running is performed in step S310. When the operation of shifting to the image for instructing the start of running is performed (YES), the CPU 1 shifts to the image for instructing to start the running at step S311. Specifically, in FIG. 12, when the next image shift instruction button 113 is operated, the CPU 1 shifts to the image for instructing the start of running and shifts the process to step S51 in FIG. 3.

When it is determined that the operation of shifting to the image for instructing the start of running is not performed (NO) in step S310, the CPU 1 returns the process to step S306.

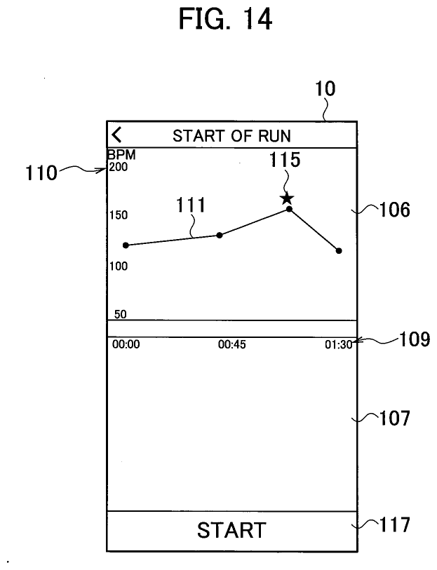

FIG. 14 shows an example of an image for instructing the start of running displayed on the display 10 in step S311. In FIG. 14, the designated music setting mark 115 is displayed at the position near the graph 111. At the lower end of the display 10, a running start button 117 described as “START” is displayed.

Next, the details of a running history selection process of step S4 will be described using FIG. 5. When “select from history” is selected in step S2 of FIG. 3, the process is shifted to step S401 of FIG. 5. In FIG. 5, in step S401, the CPU 1 shows a running history list on the display 10.

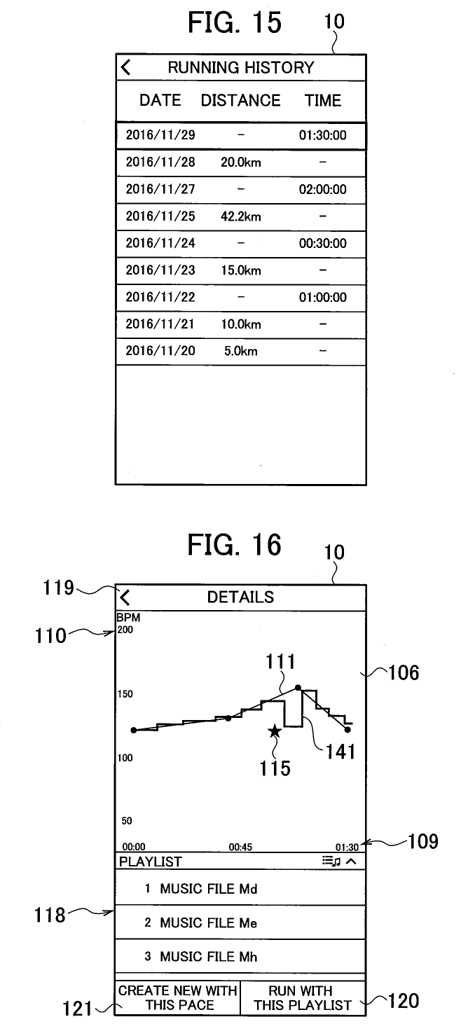

FIG. 15 shows an example of a running history list. The running history includes items of running date, distance, and time. In the case where the distance is set as shown in FIG. 9A, the distance is described in the item of distance and the time is not described, and in the case where the time is set as shown in FIG. 9B, the time is described and the distance is not described.

In step S402, the CPU 1 determines whether or not any of the running histories are selected from the running history list. When any of the running histories are not selected (NO), the CPU 1 repeats the process of step S401. When any of the running histories are selected (YES), in step S403, CPU 1 displays the corresponding graph image including the BPM graph 111, a broken line 141, and a playlist 118 on the display 10 as shown in FIG. 16.

The data showing the running history includes data showing the graph 111 set by the runner, data showing the BPM value of the reproduced music file, and data of the reproduced music playlist.

In FIG. 16, the broken line 141 indicated by a thick solid line in proximity to the graph 111 indicates the BPM value of the music file reproduced by a portable terminal from the start to the end of the running. A one line segment extending in the left and right direction of the broken line 141 indicates a period during which one music file is being reproduced, and a line segment extending in the up and down direction connecting adjacent line segments indicates a time position at which the music file is changed.

In FIG. 16 and the drawings to be described later, it is preferable to make the color of the graph 111 different from the color of the broken line 141 in the actual display 10. For example, the CPU 1 draws the graph 111 as a black solid line and draws the broken line 141 as a red solid line.

The CPU 1 draws a corresponding graph image based on the data showing the graph 111 and the data showing the BPM value of the reproduced music file, and displays the playlist 118 on the display 10 based on the data of the playlist.

The image shown in FIG. 16 includes a running history return button 119 for returning to the running history, a determination button 120 for determining to use the displayed playlist 118 described as “run in this playlist”, and a new creation button 121 for creating a new BPM graph 111 based on the displayed graph 111.

In step S404, the CPU 1 determines whether or not an instruction to return to the running history list is given by the operation of the running history return button 119. When the instruction to return the running history list is given (YES), the CPU 1 returns the process to step S401, and when the instruction to return the running history list is not given (NO), the process is shifted to step S405.

In step S405, the CPU 1 determines whether or not it is determined to use the displayed playlist 118 as the determination button 120 is operated. When the determination button 120 is not operated (NO), the CPU 1 returns the process to step S404. When the determination button 120 is operated (YES), the CPU 1 shifts to an image for instructing the start of running as in FIG. 14 in step S406, and shifts the process to step S52 in FIG. 3.

In FIG. 5, the illustration of the process in the case where the new creation button 121 is operated is omitted. In the case where the new creation button 121 is operated, the BPM graph 111 can be adjusted to set designated music file, as in FIGS. 12 and 13.

Returning to FIG. 3, in the case where the new run menu creation process of step S3 is executed, the processes of steps S51, S61, and S71 are executed.

In step S51, the CPU 1 determines whether or not the running start button 117 shown in FIG. 14 is operated by the runner to instruct the start of running. Here, for the sake of convenience, it is expressed as the instruction to start running, but strictly speaking, the instruction to start running means an instruction to select the music file which the runner listens to during the running corresponding to the BPM graph 111 set as described above and reproduce the music file.

In one or more embodiments, it is assumed that the runner listens to music files while running, so the start and the end of running is equivalent to the start and the end of music reproduction.

When the instruction to start running is not given (NO), the CPU 1 repeats the process of step S51. When the instruction to start running is given (YES), the CPU 1 executes a music selection and reproduction process in step S61, and concurrently, executes an image display process on the display 10 in step S71.

Here, the details of the music selection and reproduction process in step S61 will be described using FIGS. 6A and 6B. In FIG. 6A, the CPU 1 determines whether or not the designated music file is set at the start of the BPM graph 111 (00:00 at the start of running) in step S601.

When the designated music file is not set at the start of the BPM graph 111 (NO), the CPU 1 acquires the BPM value at the start of the BPM graph 111 in step S602. In step S603, the CPU 1 extracts music files having a BPM value approximate to the acquired BPM value. Taking the graph 111 of FIG. 14 as an example, since the BPM value at the start is 120, the CPU 1 extracts the music files having the BPM value approximate to a BPM value of 120.

As an example, the CPU 1 searches for music files having a BPM value of ±3 with reference to the acquired BPM value, and when there is a music file within the range, the CPU 1 extracts the music file within the range. When there is no music file within the range, the CPU 1 searches for music files having a BPM value of ±6, and when there is a music file within the range, the CPU 1 extracts the music file within the range. A range for expanding the search range of BPM values at one time and the number of times of expansion of the search range are arbitrary.

In step S604, the CPU 1 randomly selects and reproduces one music file from the extracted music files (a music selection step and a first reproduction step). The CPU 1 reads the music data of the selected music file from the storage device 3. The decoder 4 decodes the music data read out under the control of the CPU 1, and the D/A converter 5 converts the digital audio signal of the decoded music data into an analog audio signal. Thereby, the runner can run while listening to the music file with the headphones 7.

In step S605, the CPU 1 determines whether or not the reproduction of the entire selected one music file is completed. When the reproduction of the entire music file is completed (YES), the CPU 1 acquires the BPM value at the end of music reproduction in the BPM graph 111 in step S606, and shifts the process to step S610.

When the reproduction of the entire music file is not completed in step S605 (NO), the CPU 1 determines whether or not an instruction to end the running is given in step S607.

The CPU 1 can calculate the running distance of the runner since the start of running based on a change in the position information. The CPU 1 can detect the elapsed time from the start of running by time measurement with a clock 12. The instruction to end the running will be described later.

When the instruction to end the running is given (YES), the CPU 1 shifts the process to step S617. When the instruction to end the running is not given (NO), the CPU 1 determines whether or not the music file being reproduced is skipped in step S608. The fact that the music file being reproduced is skipped in step S608 is that an instruction step of giving an instruction to reselect the music file to be reproduced is performed in response to an operation of skipping the music file being reproduced in a first reproduction step.

When the music file being reproduced is skipped (YES), the CPU 1 acquires the BPM value at the time of the skip operation in the BPM graph 111 in step S609, and shifts the process to step S610.

As in step S603, the CPU 1 extracts the music file having the BPM value approximate to the acquired BPM value in step S610. In step S611, the CPU 1 randomly selects and reproduces one music file from the extracted music files (music selection step and first reproduction step). The CPU 1 shifts the process from step S611 to step S617.

In step S617, the CPU 1 determines whether or not the instruction to end the running is given. When the instruction to end the running is given (YES), the CPU 1 shifts the process to step S618.

When the instruction to end the running is not given in step S617 (NO), the CPU 1 returns the process to step S605.

When the music file being reproduced is not skipped in step S608 (NO), the CPU 1 determines whether or not a distance or time position at which the designated music file is set is reached in step S612 in FIG. 6B. When the distance or time position at which the designated music file is set is not reached (NO), the CPU 1 returns the process to step S605 in FIG. 6A.

When the distance or the time position at which the designated music file is set is reached in step S612 (YES), CPU 1 determines whether or not the reproduction of the entire music file being reproduced at the distance or time position at which the designated music file is set is completed in step S613. When the reproduction of the entire music file is completed (YES), the CPU 1 shifts the process to step S616.

When the reproduction of the entire music file is not completed (NO), the CPU 1 determines whether or not the music file being reproduced at the distance or time position at which the designated music file is set is skipped in step S614. When the music file being reproduced at the time position at which the designated music file is set is skipped (YES), the CPU 1 shifts the process to step S616. When the music file being reproduced at the distance or time position at which the designated music file is set is not skipped (NO), the CPU 1 determines whether or not the instruction to end the running is given in step S615.

When the instruction to end the running is not given in step S615 (NO), the CPU 1 returns the process to step S613. When the instruction to end the running is given (YES), the CPU 1 shifts the process to step S618 in FIG. 6A.

On the other hand, when the designated music file is set at the start of the BPM graph 111 in step S601 of FIG. 6A (YES), the CPU 1 shifts the process to step S616 of FIG. 6B.

When the process is shifted from step S601, step S613, or step S614 to step S616, the CPU 1 reproduces the designated music file in step S616 (second reproduction step). The CPU 1 shifts the process from step S616 to step S617 in FIG. 6A.

Also in this case, the CPU 1 determines whether or not the instruction to end the running is given in step S617. When the instruction to end the running is given (YES), the CPU 1 shifts the process to step S618.

When the process is shifted from step S607 or step S617 to step S618, in step S618, the CPU 1 stops the reproduction of the music file and shifts the process to step S8 of FIG. 3.

In the music selection and reproduction process shown in FIGS. 6A and 6B, the CPU 1 creates a playlist of the music file reproduced in step S604, step S611, and step S616 and stores the playlist in the temporary storage memory 2 (playlist creation step).

The CPU 1 may create a playlist so that music files skipped in a short time are not included in the playlist. For example, the CPU 1 may control such that the music file reproduced by more than half of the total time of the music file is included in the playlist, and the music file reproduced by less than half is not included in the playlist. It may be arbitrarily set that the music file is not included in the playlist at less than a certain percentage when the music file is skipped.

Next, the details of an image display process of step S71 will be described using FIG. 7. In FIG. 7, in step S701, the CPU 1 stores the BPM value of the music file being reproduced in the temporary storage memory 2 in correspondence with the time position. The process of storing the BPM value of the music file in the temporary storage memory 2 is continuously executed until the instruction to end the running is given.

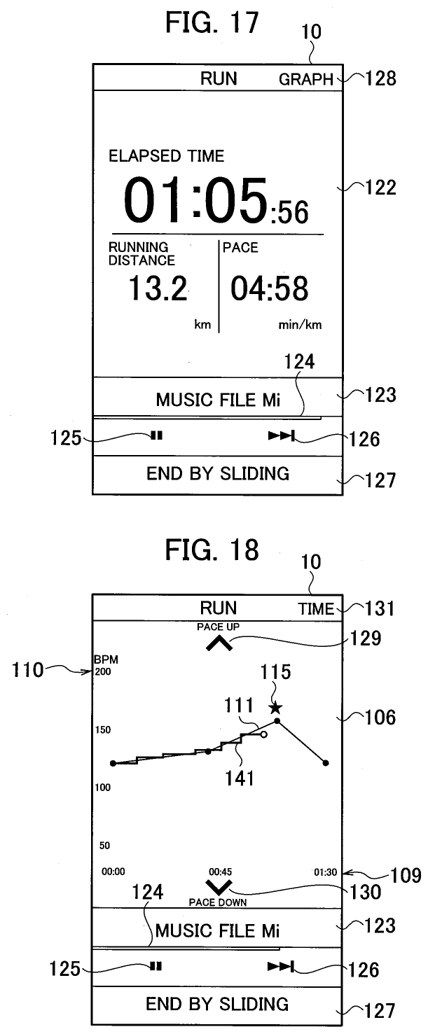

In step S702, the CPU 1 measures the elapsed time, the running distance, and the pace, and displays a time display image on the display 10. FIG. 17 shows an example of a time display image shown on the display 10 after the instruction to start running is given.

The time display image includes an area 122 for displaying an elapsed time, a running distance, and a pace, an area 123 for showing the music file being reproduced, and a progress bar 124 for showing the progress state of the music file being reproduced. The time display image further includes a pause button 125, a skip button 126, a running end button 127 described as “slide and end”, and a graph display image shift button 128 for shifting to a graph display image including the graph 111 described as “graph”.

FIG. 17 shows the case where 1 hour and 5 minutes and 56 seconds have passed since the start of running, the runner runs 13.2 km, and the pace is 4 minutes and 58 seconds per 1 km.

In step S703, the CPU 1 determines whether or not the instruction to end the running is given by the operation of the running end button 127. The determination as to whether or not the instruction to end the running is given in steps S607 and S616 of FIG. 6A is that whether or not the run end button 127 is operated. That is, steps S607 and S617 of FIG. 6A and step S703 of FIG. 7 are the same process.

When the instruction to end the running is not given in step S703 (NO), the CPU 1 determines whether or not an instruction to shift to a graph display image is given by the operation of the graph display image shift button 128 in step S704. When the instruction to shift to a graph display image is not given (NO), the CPU 1 returns the process to step S702 and repeats the processes of steps S702 to S704. Thus, the time display image of FIG. 17 is continuously displayed on the display 10.

When the instruction to shift to a graph display image is given in step S704 (YES), the CPU 1 shifts to a graph display image as shown in FIG. 18 in step S705 (graph image display step). In FIG. 18, the same parts as those of the image shown in FIG. 17 or the drawings before FIG. 17 are denoted by the same reference numerals.

The graph display image includes a corresponding graph image including the BPM graph 111 and the broken line 141 showing the BPM value of the reproduced music file. Here, since it is a time during which the running is not ended yet, the broken line 141 is drawn halfway.

The graph display image also includes a pace up button 129 for increasing the running pace, a pace down button 130 for reducing the pace, and a time display image shift button 131 for returning to the time display image described as “time”.

Here, for the sake of convenience, it is expressed as increasing and decreasing the running pace, but strictly speaking, it means increasing and decreasing the BPM of the music file which the runner listens to during the running. The runner can easily increase the running pace by raising the BPM of the music file to listen to while running, and can decrease the running pace by lowering the BPM.

In step S706, the CPU 1 determines whether the running pace is increased or decreased by the operation of the pace up button 129 or the pace down button 130. When the operation to increase or decrease the running pace is performed (YES), the CPU 1 changes the set BPM graph 111 in step S707 (change step). The CPU 1 shifts the process from step S707 to step S708.

When it is determined that the running pace is not increased or decreased (NO) in step S706, the CPU 1 shifts the process to step S708.

In step S708, the CPU 1 determines whether or not the instruction to end the running is given. When the instruction to end the running is not given (NO), the CPU 1 determines whether or not the instruction to return to the time display image is given by the operation of the time display image shift button 131 in step S709. When the instruction to return to the time display image is given (YES), the CPU 1 returns the process to step S702. Thus, the display state of the display 10 is returned to the time display image similar to FIG. 17.

When the instruction to return to the time display image is not given in step S709 (NO), the CPU 1 returns the process to step S705. Thus, the graph display image of FIG. 18 is continuously displayed on the display 10.

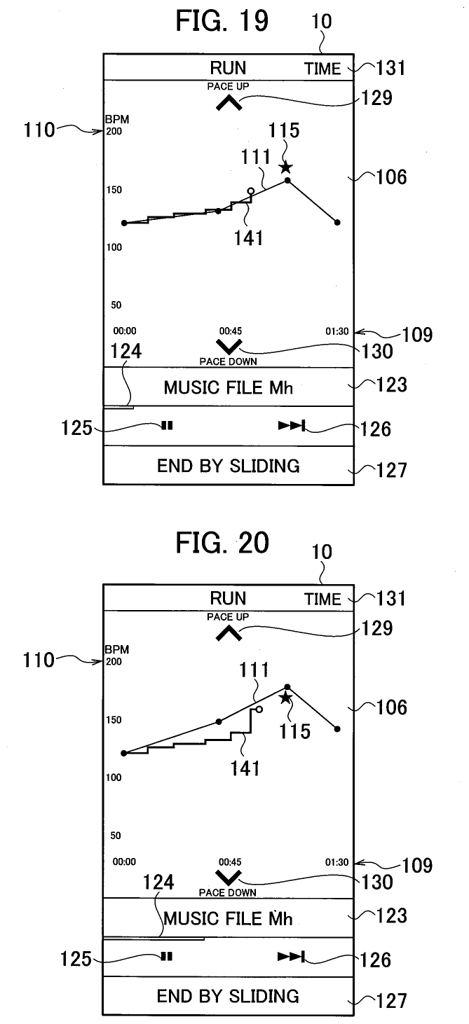

FIGS. 19 and 20 respectively show examples of the graph 111 before and after the change in the case where the operation of increasing the running pace is performed in step S706 and the BPM graph 111 is changed in step S707. As shown in FIG. 20, as the BPM value is increased, the music file having a high BPM value is selected and reproduced. The CPU 1 may move the graph 111 parallel in the up and down direction by operation of the pace up button 129 or the pace down button 130.

On the other hand, when the instruction to end the running is given in step S703 or step S708 (YES), CPU 1 displays a running result image on the display 10 in step S710.

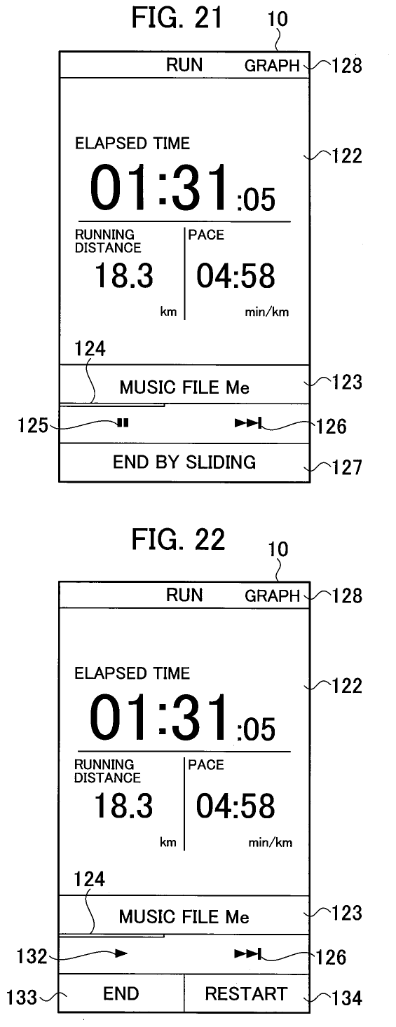

Specifically, it is as follows. FIG. 21 shows a time display image after the end of 1 hour and 30 minutes of running. When the running end button 127 is operated, the CPU 1 stops the reproduction of the music file, and displays the reproduction button 132 instead of the pause button 125 as shown in FIG. 22.

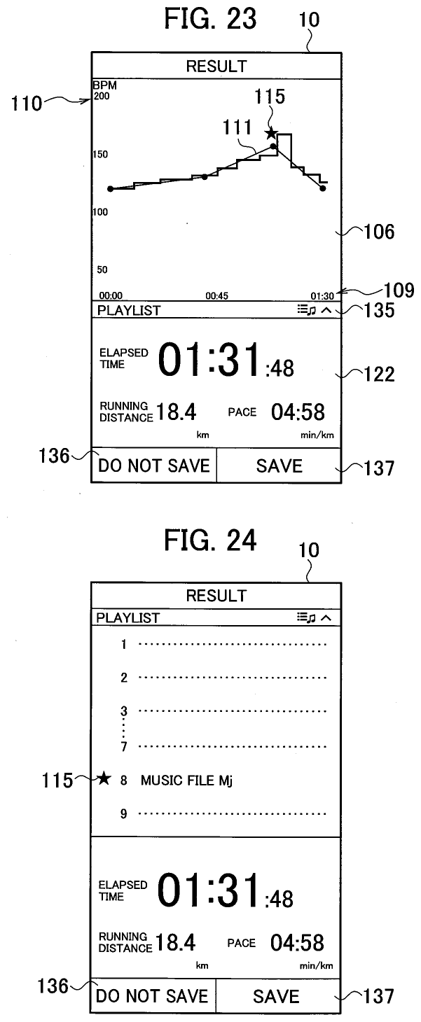

In FIG. 22, when the end button 133 is operated, the CPU 1 displays a running result image as shown in FIG. 23 on the display 10. In FIG. 23, the reason why the time position of the designated music setting mark 115 and the time position of the broken line 141 at which the music file is changed are deviated is that the time position of the designated music setting mark 115 is not the time position of the start of the reproduction of the designated music file.

In FIG. 22, when a restart button 134 is operated, the CPU 1 can restart the reproduction of the music file. For example, the CPU 1 reproduces the music file corresponding to the BPM value at the end of the BPM graph 111.

As shown in FIG. 23, the running result image includes a playlist shift button 135 for shifting to the display of the playlist, a non-saving button 136 for discarding without saving the running result and the playlist described as “do not save”, and a save button 137 for saving the running result and the playlist described as “save”.

The running result is data stored in the temporary storage memory 2 in order to draw the corresponding graph image including the BPM graph 111 (and the designated music setting mark 115) and the broken line 141.

Returning to FIG. 7, in step S711, the CPU 1 determines whether or not an instruction to display the playlist is given by the operation of the playlist shift button 135. When the instruction to display the playlist is given (YES), the CPU 1 displays the playlist display image on the display 10 based on the data of the playlist stored in temporary storage memory 2 in step S712 as shown in FIG. 24 (playlist display step).

Subsequently to step S712, the CPU 1 shifts the process to step S713. When the instruction to display the playlist is not given in step S711 (NO), the CPU 1 shifts the process to step S713.

In step S713, the CPU 1 determines whether or not an instruction to save the running result and the playlist is given by the operation of the save button 137 (whether an instruction to discard the running result and the playlist is given by the operation of the non-save button 136).

When the instruction to save the running result and the playlist is given (YES), the CPU 1 saves the running result and the playlist stored in the temporary storage memory 2 in the storage device 3 in step S714, and shifts the process to step S8 in FIG. 3. When the instruction to save the running result and the playlist is not given (NO), the CPU 1 discards the running result and the playlist stored in the temporary storage memory 2 in step S715, and shifts the process to step S8 in FIG. 3.

Returning to FIG. 3, in the case where the running history selection process of step S4 is performed, the processes of steps S52, S62, and S72 are performed. As in step S51, the CPU 1 determines whether or not the instruction to start running is given in step S52. When the instruction to start running is not given (NO), the CPU 1 repeats the process of step S52.

When the instruction to start running is given (YES), the CPU 1 executes playlist reproduction for reproducing the music file of the playlist in step S62, and in parallel, performs an image display process on the display 10 in step S72. The image display process in step S72 is similar to the process in step S71. However, the image display process in step S72 may include at least processes for displaying a time display image or a graph display image as described in FIGS. 17, 18, 21, and 22 among the detailed processes of step S71 shown in FIG. 7.

Also in step S62, as in step S61, the CPU 1 stops the reproduction of the music file when the instruction to end the running is given. The CPU 1 shifts the process from step S62 and step S72 to step S8.

Even the case where the run menu is selected from the running history, as described in FIGS. 19 and 20, it may be configured to change the running pace (BPM). When the running pace is changed, the music file different from the music file set in the running history playlist is selected and reproduced.

In this case, as in FIGS. 23 and 24, it may be configured to select whether or not to save the running result and the playlist. When the instruction to save the running result and the playlist is given, a new running result and a new playlist are saved in the storage device 3.

In FIG. 3, in step S8, the CPU 1 returns the display state of the display 10 to the menu of FIG. 8, and shifts the process to step S9. In step S9, the CPU 1 determines whether or not an instruction to end the application program is given. For example, the home button provided on the housing of the portable terminal can be used as an operation button for ending the application program.

When the instruction to end the application program is given (YES), the CPU 1 ends the process. When the instruction to end the application program is not given (NO), the CPU 1 returns the process to step S8.

Furthermore, a switching operation (switching process) of the music file to be reproduced in one or more embodiments will be collectively described using FIG. 25 to FIG. 27. In FIG. 25 to FIG. 27, the numbers surrounded by squares indicate the BPM values of the music file stored in the storage device 3. In FIG. 25 to FIG. 27, the BPM value of the graph 111 is rapidly increased to facilitate the description. The time on the time axis corresponds to the advancing of time or distance.

In FIG. 25, since the BPM value of the graph 111 is 120 at the time t1, the CPU 1 selects a music file Md having a BPM value of 120 as a music file having a BPM value within a predetermined range based on the BPM value of 120. As long as the skip operation is not performed, the music file Md is reproduced from the time t1 when the reproduction is started to the time t2 when the reproduction of the entire music file is completed.

Since the BPM value of the graph 111 is 133 at the time t2, the CPU 1 selects a music file Mf having a BPM value of 135 as a music file having a BPM value within a predetermined range based on the BPM value of 133. Thus, the music file to be reproduced is switched from the music file Md to the music file Mf.

In FIG. 25, since the BPM value of the graph 111 is increased during the reproduction of the music file Md, the BPM of a music file Me having a BPM value of 124 or a music file Mh having a BPM value of 125 is close to the BPM value set in the graph 111. However, in one or more embodiments, regardless of whether or not the BPM value of the graph 111 exceeds a predetermined range based on the BPM value (here, 120) of the graph 111 at the time when the music file Md is selected during the reproduction of the music file Md, the reproduction of the music file Md is continued.

In one or more embodiments, the music file Mf having a BPM value within a predetermined range based on the BPM value of the graph 111 in the time when the reproduction of the entire music file Md is completed is selected. Therefore, according to one or more embodiments, since the music file is not switched halfway, the runner can run while enjoying favorite music corresponding to the running pace.

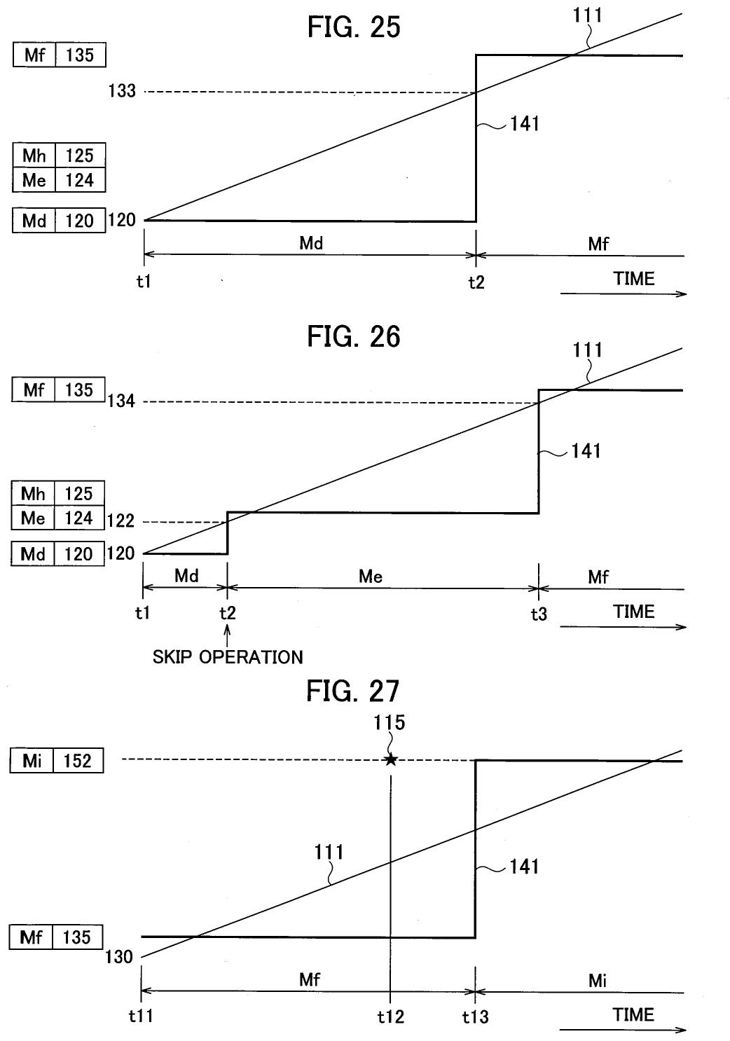

FIG. 26 shows a music switching operation in the case where an operation to skip music file is performed. In FIG. 26, it is assumed that the reproduction of the music file Md is started at the time t1 and the skip operation is performed at the time t2. The CPU 1 selects a music file having a BPM value within a predetermined range based on the BPM value (here, 122) of the graph 111 at the time t2 when the skip operation is performed.

For example, the CPU 1 selects the music file Me having a BPM value of 124, and the music file Me is reproduced from the time t2 when the reproduction is started until the time t3 when the reproduction of the entire music file is completed. The switching of the music file at the time t3 is similar to that at the time t2 in FIG. 25.

In the example shown in FIG. 26, the BPM value of 120 of the music file Md is within a predetermined range based on a BPM value of 122 of the graph 111 at the time t2. Accordingly, when the CPU 1 randomly selects a music file having a BPM value within a predetermined range based on the BPM value of the graph 111 at the time t2, the possibility that the music file Md may be selected again is not zero. However, as long as a large number of music files are stored in the storage device 3, the possibility that the music file Md may be selected again is extremely low, and another music file is selected and reproduced.

Of course, when the BPM value of the music file being reproduced immediately before the skip operation is not included within the predetermined range based on the BPM value of the graph 111 at the time when the skip operation is performed, the music file to be reproduced is switched to another music file.

The instruction step of giving an instruction to select the music file to be reproduced again by the operation of skipping the music file is substantially equivalent to the switching step of switching the music file to be reproduced to another music file.

FIG. 27 shows a music switching operation in the case where the designated music file is set. In FIG. 27, the time t12 is set as a specific progress time point for reproducing the designated music file, and a music file Mi having a BPM value of 152 is set as the designated music file. It is assumed that the CPU 1 selects the music file Mf having a BPM value of 135 as a music file having a BPM value within a predetermined range based on the BPM value of 130 of the graph 111 at the time t11.

During the reproduction of the music file Mf, the time reaches the time t12 set to reproduce the music file Mi of the designated music file. However, in one or more embodiments, even when the progress time point reaches a specific progress time point during the reproduction of the music file Mf, at the time t13 when the reproduction of the entire music file Mf being reproduced immediately before the specific progress time point is completed, the music file to be reproduced is switched from the music file Mf to the music file Mi.

Therefore, according to one or more embodiments, since the music file is not switched halfway, the runner can run while enjoying favorite music files corresponding to the running pace.

As described above, the application program which is the music reproduction program according to each of one or more embodiments causes the CPU 1 (computer) to execute the above-described steps. As shown in FIG. 1, the music reproduction device according to one or more embodiments has an application program installed to execute each of the above-described steps.

The music reproduction device according to one or more embodiments may be configured to include hardware that performs operations corresponding to each of the above-described steps. The music reproduction device may include a graph setting unit which sets the BPM graph as described above, a music selection unit which selects music as so as described above, and a reproduction unit which reproduces the music file selected by the music selection unit so that the user can listen to the music file.

Preferably, the music reproduction device includes an instruction unit that gives an instruction to select music file to be reproduced again in response to the operation of skipping the music file. Preferably, the music reproduction device includes a designated music setting unit which sets music file designated to be reproduced at a specific progress time point.

Preferably, the music reproduction device includes a graph image display unit which displays a graph image on the display. Preferably, the music reproduction device includes a change unit which changes the BPM graph. Preferably, the music reproduction device includes a playlist creation unit which creates a playlist of the reproduced music files, and a playlist display unit which displays the playlist on the display.

The music reproduction program may be provided to any third party or any electronic device through a communication line such as the Internet and may be downloaded to the electronic device. The music reproduction program may be stored in a non-transitory storage medium and provided to any third party. The music reproduction device may have a configuration in which software and hardware are mixed. The use of software and hardware is optional. The hardware may be an integrated circuit.

What is claimed is:

1. A computer software product that includes a non-transitory storage medium readable by a processor, the non-transitory storage medium having stored thereon a set of instructions for performing music reproduction, the instructions comprising:
a first set of instructions of setting a BPM graph showing a tempo of a music file that a user listens to from a start to an end of exercise at a distance or time preset when the user does a predetermined exercise;
a second set of instructions of, when setting a music file that the user listens to at any progress time point in the distance or time after the start of the exercise, selecting a music file having a BPM value within a predetermined range based on a BPM value at a progress time point in the graph set in the setting of the graph; and
a third set of instructions of reproducing the music file selected in the selecting of the music file to make the user listen to the music file,
wherein the second set of instructions selects, when selecting a second music to be reproduced next to a first music being reproduced by the third set of instructions, during the reproduction of the first music file, regardless of whether or not the BPM value set in the graph exceeds the predetermined range based on a BPM value set in the graph at a progress time point when the first music file is selected, a music file having a BPM value within the predetermined range based on a BPM value set in the graph at a process time point when the reproduction of the entire first music file is completed.

2. The computer software product according to claim 1, the instructions further comprising a fourth set of instructions of giving an instruction to select music file to be reproduced again in response to an operation of skipping the music file being reproduced by the third set of instructions,
wherein the second set of instructions selects, during the reproduction of the first music file by the third set of instructions, when the instruction to select a music file to be reproduced again is given by the fourth set of instructions, a music file having a BPM value within the predetermined range based on a BPM value set in the graph at a progress time point when the operation of skipping the first music file is performed.

3. The computer software product according to claim 1, the instructions further comprising:
a fifth set of instructions of setting any progress time point during a period from the start to the end of the exercise to a specific progress time point to reproduce a designated music file, and setting the designated music file to be reproduced at the specific progress time point; and
a sixth set of instructions of reproducing the designated music file to make the user listen to the music file at a progress time point when reproduction of the entire music file being reproduced immediately before the specific progress time point is completed even when the progress time point reaches to the specific progress time point.

4. The computer software product according to claim 1, the instructions further comprising a seventh set of instructions of displaying a graph image in which a BPM value of the music file reproduced by the third set of instructions is associated with the graph set by the first set of instructions on a display.

5. The computer software product according to claim 3, the instructions further comprising an eighth set of instructions of displaying a graph image in which the BPM value of the music file reproduced by the third set of instructions or the fifth set of instructions is associated with the graph set by the first set of instructions on a display,
wherein the seventh set of instructions comprises a set of instructions of displaying, in addition, to the graph image associated with the BPM value, a mark indicating the specific progress time point on the display.

6. The computer software product according to claim 1, the instructions further comprising a ninth set of instructions of changing the BPM graph in response to an operation of changing the graph set at any progress time point by the first set of instructions in a direction in which the BPM value increases or decreases,
wherein the second set of instructions selects a music file based on the changed graph after the BPM graph is changed in the change step.

7. The computer software product according to claim 1, the instructions further comprising:
a tenth set of instructions of creating a music playlist reproduced by the third set of instructions during the period from the start to the end of the exercise; and
an eleventh set of instructions of displaying the playlist on a display.

8. The computer software product according to claim 2, the instructions further comprising:
a twelfth set of instructions of creating a music playlist reproduced by the third set of instructions during the period from the start to the end of the exercise; and
a thirteenth set of instructions of displaying the playlist on a display.
wherein the twelfth set of instructions creates the playlist so as not to include a music file on which the operation of skipping the music file is performed at less than a predetermined percentage in the time of the entire music file in the playlist.

9. A music reproduction device comprising:
a graph setting unit configured to set a BPM graph showing a tempo of a music file that a user listens to from a start to an end of exercise at a distance or time preset when the user does a predetermined exercise;
a music selection unit configured to select, when a music file that the user listens to is set at any progress time point in the distance or time after the start of the exercise, a music file having a BPM value within a predetermined range based on a BPM value at a progress time point in the graph set in the graph setting unit; and
a reproduction unit configured to reproduce the music file selected by the music selection unit so that the user can listen to the music file,
wherein the music selection unit selects, when a second music file to be reproduced next to a first music file being reproduced by the reproduction unit, during the reproduction of the first music file, regardless of whether or not the BPM value set in the graph exceeds the predetermined range based on a BPM value set in the graph at a progress time point when the first music file is selected, a music file having a BPM value within the predetermined range based on a BPM value set in the graph at a process time point when the reproduction of the entire first music file is completed.

10. A music reproduction method comprising:
setting a BPM graph showing a tempo of a music file that a user listens to from a start to an end of exercise at a distance or time preset when the user does a predetermined exercise by a processor of an electronic device;
when selecting a music file that a user listens to among a plurality of music files stored in the electronic device at any progress time point from the start to the end of the exercise, selecting a music file having a BPM value within a predetermined range based on the BPM value at the progress time point in the graph by the processor; and
reproducing the selected music file by a reproduction unit provided in the electronic device to make the user listen to the music file,
wherein the processor selects, when a second music file to be reproduced next to a first music file being reproduced is selected, during the reproduction of the first music file, regardless of whether or not the BPM value set in the graph exceeds the predetermined range based on a BPM value set in the graph at a progress time point when the first music file is selected, a music file having a BPM value within the predetermined range based on a BPM value set in the graph at a process time point when the reproduction of the entire first music file is completed.
